(19) United States
(12) Patent Application Publication
(10) Pub. No.: US 2004/0223189 A1
(43) Pub. Date: Nov. 11, 2004

(54) Rapid design of smooth multi-level multi-frequency screens

(76) Inventor: Anoop Bhattacharjya, Campbell, CA (US)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/435,445

(22) Filed: May 9, 2003

(51) Int. Cl. H04N 1/405; H04N 1/52

(52) U.S. Cl. 358/3.11; 358/3.16; 358/3.14; 358/536; 358/3.2

(57) ABSTRACT

A method/algorithm enables the rapid development and tuning of multi-level and multi-frequency halftone screens to improve printer performance. The screens are primarily directed to laser printers. The method/algorithm generally involves generating a lattice of points by selecting a plurality of points along an imaginary line whose path extends along a surface of a geometric shape; assigning a dot shape to each of the lattice points; selecting a growth model for each dot shape; quantizing the lattice points and assigned dots to a specified grid of pixels; and generating multi-frequency screens from the lattice of points and associated dots.

### BACKGROUND OF THE INVENTION

1. Field of the Invention

The present invention relates to a method/algorithm for developing multi-level and multi-frequency halftone screens, targeted primarily for laser printers. The method/algorithm of the present invention, which enables rapid design of the screens, may be embodied in an apparatus such as a computer, or as a program of instructions (e.g., software) embodied on a machine-readable medium.

2. Description of the Related Art

Laser printers are beset with a number of color-stability problems that arise from the physics of the toner transfer process and mechanical design of the printer. Fast tandem printers that use multiple drums to transfer toner to the paper are especially susceptible to these problems.

Screen design is very important to the perceived image quality of printer output. The screen must not only allow the rendering of a large number of colors (i.e., have a large color gamut), it must also have good color stability and smooth fine-scale structure while maintaining the capability of rendering with high spatial resolution.

It is therefore important to take into account the combination of toner-transfer color-stability problems and good screen properties in designing screens for a given laser print engine. However, doing so entails a significant experimental component that makes the design process time consuming and relatively complicated.

### OBJECTS OF THE INVENTION

It is therefore an object of the present invention to overcome this problem.

It is a further object of this invention to provide a method/algorithm for rapidly generating a large family of screens that can be tuned rapidly to maximize screening performance for a given printer.

### SUMMARY OF THE INVENTION

According to one aspect of this invention, a method for developing multi-frequency screens for a printer is provided. The method comprises the steps of generating a lattice of points by selecting a plurality of points along an imaginary line whose path extends along a surface of a geometric shape; assigning a dot shape to each of the lattice points; selecting a growth model for each dot shape; quantizing the lattice points and assigned dots to a specified grid of pixels; and generating multi-frequency screens from the lattice of points and associated dots.

Preferably, the geometric shape is a torus, and a screen angle is determined as an angle made by the line with a large circle of the torus.

Preferably, the dot shape assigned to a particular lattice point is determined using a tessellation. The dot shape assigned to a particular lattice point can also be selected from the group of shapes consisting of circles, ellipses, and polygons.

The growth model for a particular dot shape is preferably selected from the group consisting of uniform growth models, directional growth models, and neighborhood-dependent growth models.

Preferably, the specified grid of pixels is a W×W grid of pixels, and the step of quantizing comprises computing the output at each location in the W×W grid for a corresponding input tone level and quantizing each output.

In another aspect, the invention involves an apparatus for developing multi-frequency screens for a printer. The apparatus, which may be a computer, printer, or photocopier, generally comprises components configured to carry out the processing described above. Such components may be embodied in a processing device, which may comprise one or more integrated circuit chips. The processing device may comprise any combination of the following: central processing unit (CPU), application specific integrated circuit (ASIC), and digital processing circuitry. The processing device may be controlled by software.

In accordance with further aspects of the invention, the above-described method or any of the steps thereof may be embodied in a program of instructions (e.g., software) which may be stored on, or conveyed to, a computer or other processor-controlled device for execution. Alternatively, the method or any of the steps thereof may be implemented using functionally equivalent hardware (e.g., ASIC, digital signal processing circuitry, etc.) or a combination of software and hardware.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a flow chart illustrating the basic processing steps of a method/algorithm for developing multi-frequency screens, according to embodiments of the invention.

FIGS. 2 and 3 are schematic illustrations of how a lattice of dots are generated on a torus.

FIG. 4 is a schematic illustration showing a regular grid of lattice points and respective Voronoi cells.

FIG. 5 is a schematic illustration showing another regular grid of lattice points and respective Voronoi cells.

FIG. 6 is a schematic illustration showing the use of three shapes assigned to different points in a regular lattice.

FIG. 7 is a schematic illustration showing the use of three shapes assigned to different points in a regular lattice, along with the respective Voronoi cells.

FIG. 8 is a schematic illustration showing how the three shapes grow and result in a darker gray level.

FIGS. 9 and 10 are schematic illustrations of exemplary data structures for using the multi-frequency screens to generate outputs for corresponding input tones.

FIG. 11 is a block diagram of an exemplary image processing system which may be used to implement embodiments of the method/algorithm of the present invention.

### DESCRIPTION OF THE PREFERRED EMBODIMENTS

A. The Basic Parameters

Line and cluster-dot screens have been found to generate the smoothest screens for laser printers. However, their design is often done manually by manipulating arrays of thresholds to grow clusters of dots or lines called screen arrays, which are tiled repetitively over the input image to determine the printer control parameters for each input image pixel.

The design elements for such screen design are the size of the screen array, the spacing between dots/lines, the angles formed between lines, the shapes of dots, the growth pattern of dots with increasing tone level, and the number of levels in the outputs that control the printer engine. The problem of generating multi-frequency screens can be thought of as a special case of the joint problem of designing dot spacing and growth patterns where both the number of dots and dot size are allowed to change.

The method/algorithm of the present invention advantageously allows each of the above parameters to be specified and also supports the generation of multi-frequency screens for each color channel. The inventive method/algorithm thus provides a flexible formalization of parameters to allow automated screen design for line/clustered-dot screens. The growth rate of dots can be controlled independently or as a function of the shape and coverage of neighboring dots. Dot shape need not be fixed; rather it may change based on the dot-growth function. Multi-level and multi-frequency screens may be generated. Line angle and dot density may be tuned to maximize color stability and screening performance.

B. The Method/Algorithm

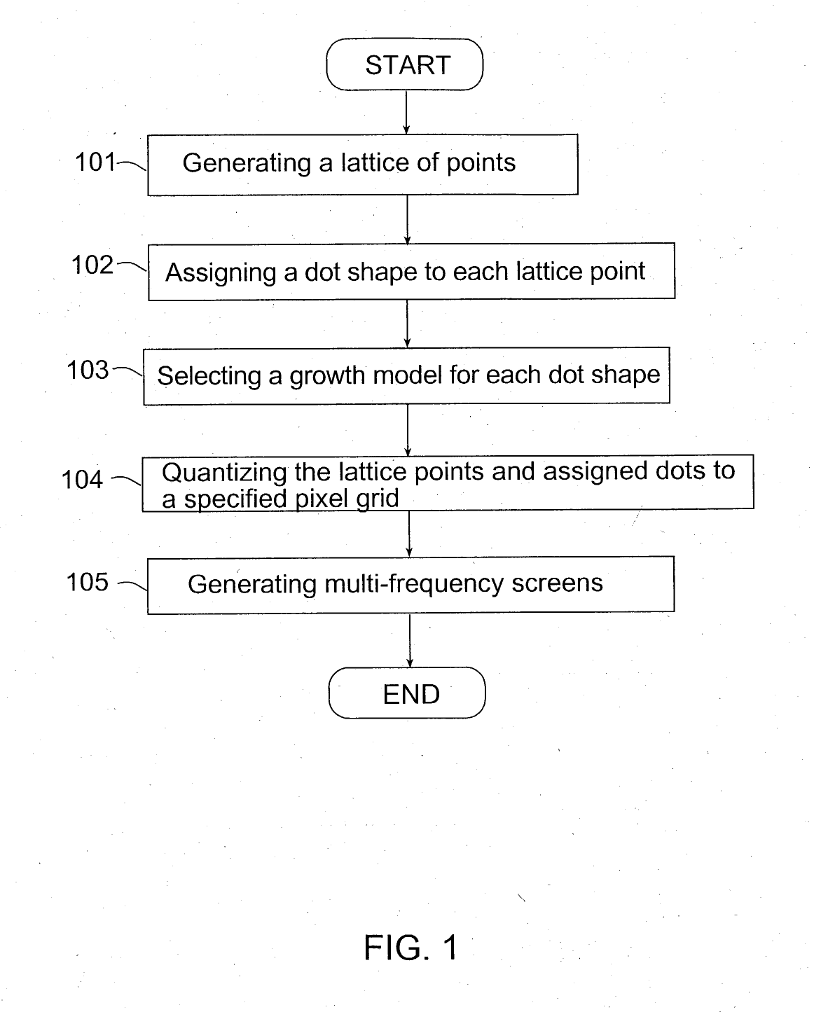

Referring to FIG. 1, the method/algorithm of the present invention is generally comprised of the following steps: generating a lattice of points (step 101); assigning a dot shape to each lattice point (step 102); selecting a growth model for each dot shape (step 103); quantizing the lattice points and assigned dots to a specified pixel grid (step 104); and generating multi-frequency screens (step 105). Each of these steps is described in detail below.

B.1. Lattice Generation

To ensure that no boundary artifacts are seen as a result of performing operations by repetitively tiling the screen over the input image, the lattice of dot centers is preferably generated on a torus (step 101). The screen angle is the angle made with the large circle of the torus. A line drawn at a given angle will wind around the torus and will be periodic if the tangent of the angle is rational. If the tangent of the angle is specified as the ratio p/q where p and q are mutually prime integers, the line will wind around the torus p+q−1 times. Thus, higher values of p and q give rise to higher screen frequencies, while the ratio p/q defines the screen angle.

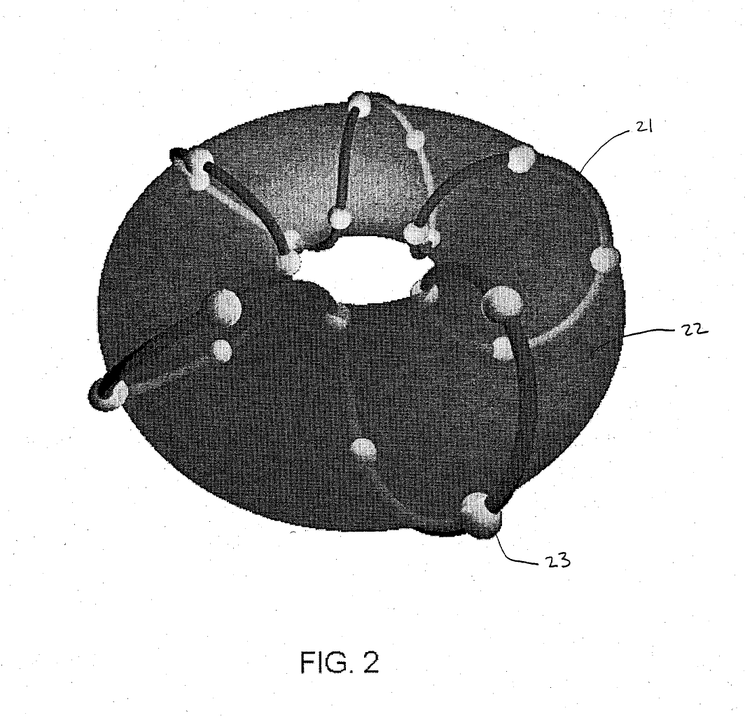

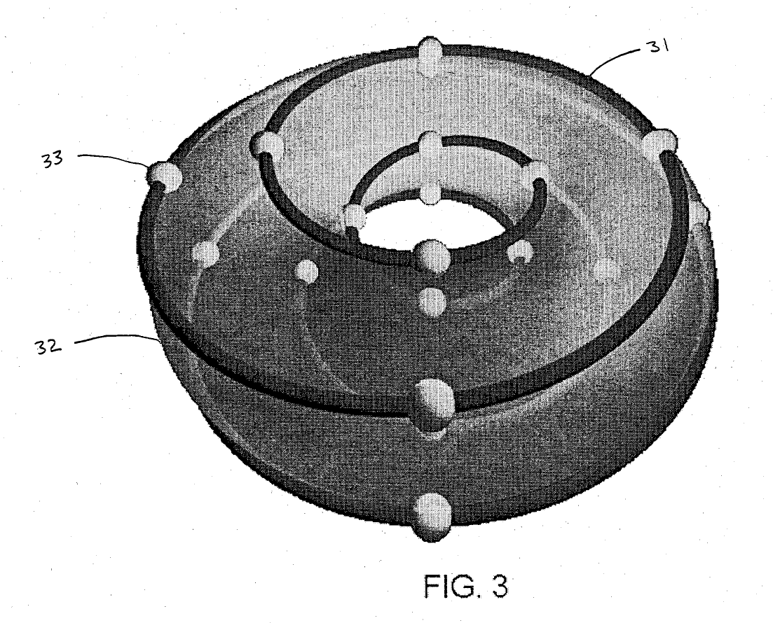

FIGS. 2 and 3 illustrate the mathematical concepts. FIG. 2 shows how a line 21 with a rational slope p/q wraps around a torus 22 in accordance with this aspect of the invention. The line 21 has a finite length, and dividing it equally as shown by the markers 23 results in a uniform dot distribution on the torus. Cutting the torus 22 and laying it flat yields a rectangular tile that can be used to tile two dimensions seamlessly. FIG. 3 shows another way in which a line 31 can wrap around a torus 32 to generate a uniform dot distribution, as indicated by the markers 33, on the torus.

A lattice of points is generated by picking N uniformly distributed points along this line according to the following relation:

$$( {x}_{i} , {y}_{i} ) = ( frac ( \frac{i p}{N} ) , frac ( \frac{i q}{N} ) ) , i ∈ \{ 0 , 1 , … , N - 1 \} \qquad ( 1 )$$

where frac(x) denotes the fractional part of x. Note that the coordinates specified in equation (1) belong to the Unit Square [0,1]²). Tiling this unit square on a plane leads to a smooth distribution of dots with no boundary artifacts. The parameter N controls the spacing between dots. For example, choosing N in the vicinity of

$$\frac{pq}{{l}_{y} \sqrt{{p}^{2} + {q}^{2}}} , where {l}_{y} = min ( frac ( \frac{iq}{N} ) , i ∈ \{ 0 , 1 , … , N - 1 \} ) ,$$

yields uniformly spaced dots such that the distance between lines is equal to the distance between dots. Choosing a larger N (more dots) makes the distance between dots along lines smaller than the distance between lines.

The phase of the dot pattern may be shifted by adding phase terms θₓ and θ_{y} yielding:

$$( {x}_{i} , {y}_{i} ) = ( frac ( \frac{i p + {φ}_{x}}{N} ) , frac ( \frac{i q + {φ}_{y}}{N} ) ) , i ∈ \{ 0 , 1 , … , N - 1 \} \qquad ( 2 )$$

The lattice for a screen may be generated by combining the lattice points from one or more phases generated to equation (2).

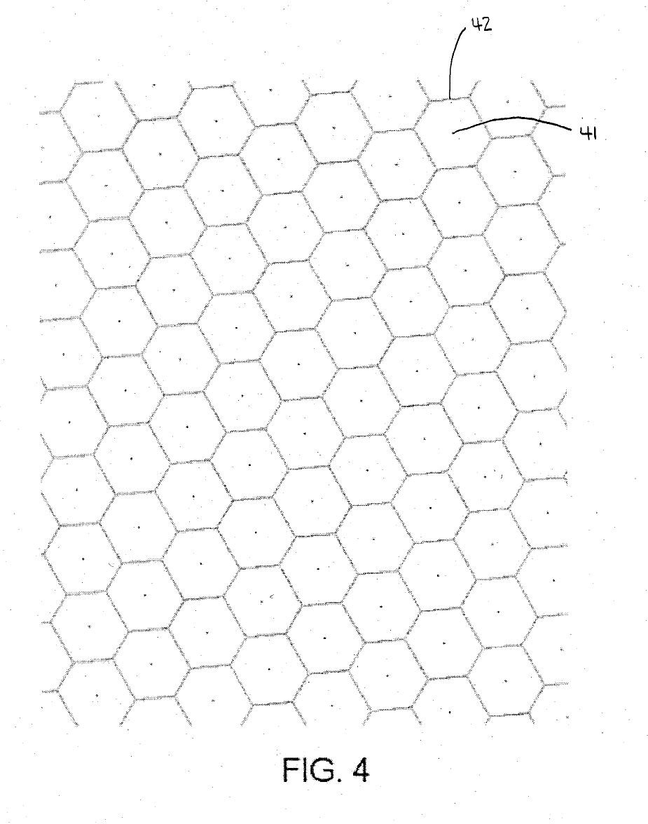

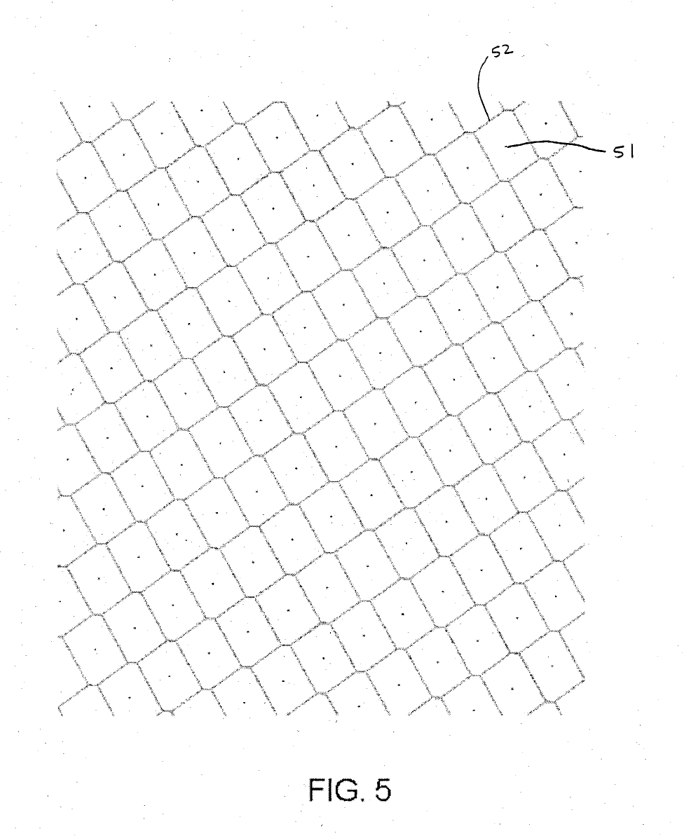

FIGS. 4 and 5 each show a regular grid of lattice points, generated according to the techniques described above. As illustrated in the figures, each lattice point 41, 51 is contained within a region known as a Voronoi cell 42, 52 which is described below. In addition to regular lattices, the invention also encompasses random lattices, which may be generated according to methods for generating dispersed-dot screens.

B.2. Dot Shapes and Growth

In step 102 a dot shape is assigned to each lattice location, and a growth model for each shape is selected in step 103. A Voronoi tessellation of the lattice determines a natural area for each lattice location. The Voronoi cell associated with a given lattice point contains all points that are closer to it than any other lattice point. The vertices of the Voronoi cell associated with a lattice location i are denoted by the set {νᵢₖ}, where k indexes each vertex of the Voronoi cell.

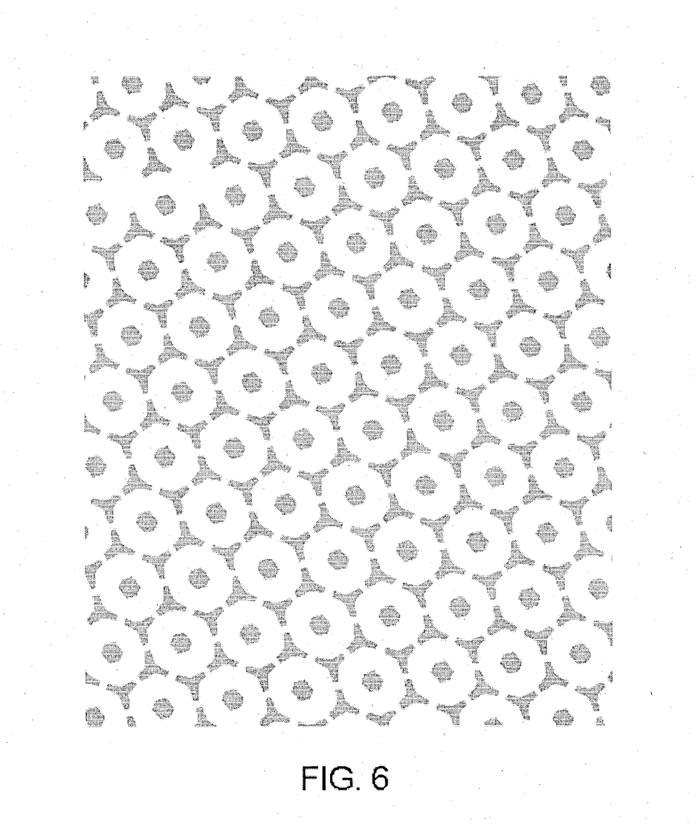

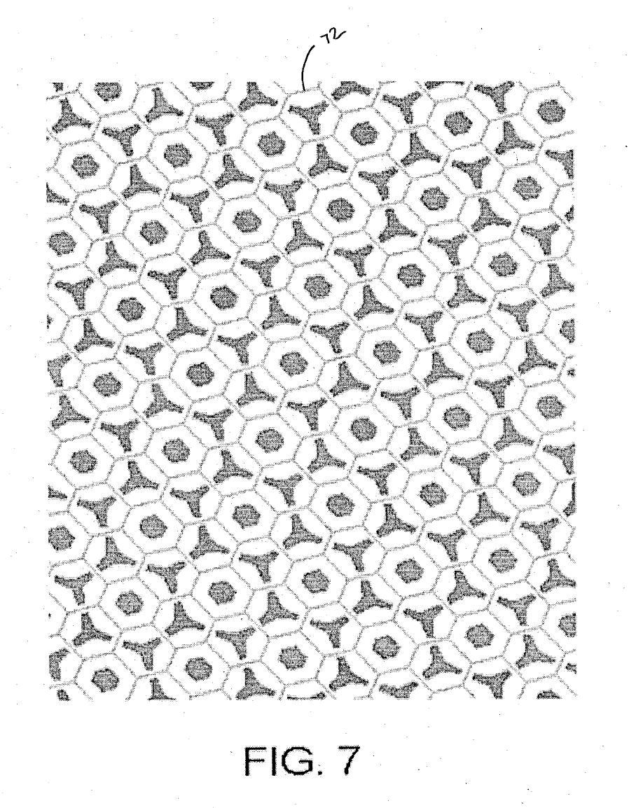

In one embodiment, three shapes of dots are used, as shown in FIG. 6. As shown in the figure, each individual shape is associated with a respective one of the regular lattice points. FIG. 7 also shows the use of three dot shapes assigned to different points in a regular lattice, as in FIG. 6. However, in FIG. 7 the dots are shown in relation to their respective Voronoi cells 72. In these illustrated examples, the dot shapes are centered on their respective lattice points, although this is not a requirement. The shape at a given gray level need not cover the associated lattice point.

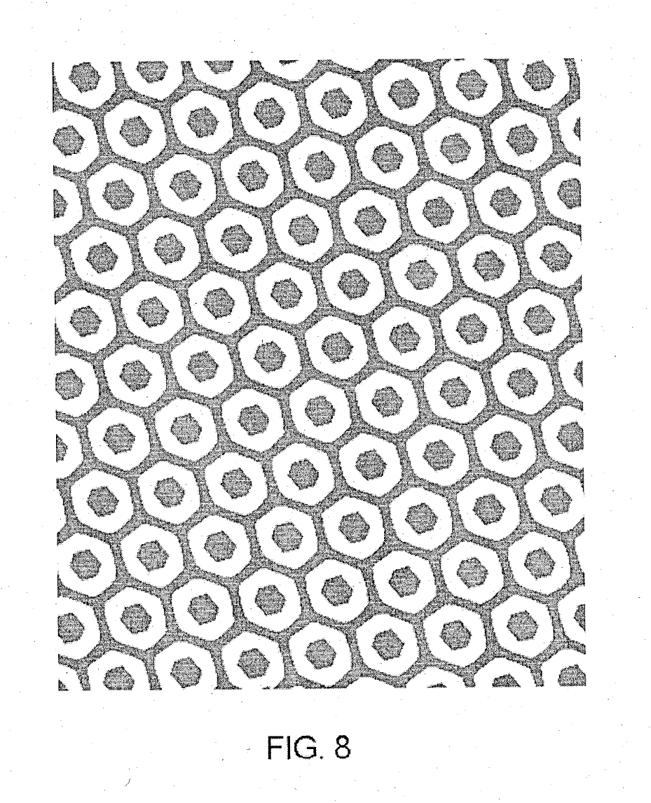

Several different growth models are possible for growing the dot shapes, the simplest being a uniform growth model given by {ανᵢₖ}, where a ranges from 0 to 1 as the tone increases from no strength to full strength. In general, any function that ranges between 0 and 1 can be used to generate the scaling factor. For laser printers, typically a gamma function using a gamma value that compensates for the dot-gain characteristic of the toner and paper may be used. FIG. 8 shows an example of how three dot shapes grow according to the uniform growth model, resulting in a darker gray level. To guarantee complete coverage, the shape associated with a lattice point should completely cover (or be larger than) the associated Voronoi cell at the gray level corresponding to the darkest tone.

Directional growth models are incorporated by making α a function of orientation. Using this technique, the dot can be made to grow faster along preferred directions.

Neighborhood-dependent growth models are incorporated by making a a function of the areas painted by the dots growing in a given lattice point's neighborhood. In this process, a neighborhood of the lattice is divided into sectors, and the directional growth along a direction is determined as a function of the area of the sector (in the chosen direction) that has already been painted.

Dot shapes other than the Voronoi tessellation may be chosen from a fixed library of shapes such as circles, ellipses and polygons. These shapes are grown by scaling and growth as described above. To ensure complete coverage, these shapes must cover the Voronoi cell, when scaled to full-strength tone value.

Multi-frequency screens are generated by marking a subset of points in the lattice as delayed growth points. The scaling functions of these points remain at zero for initial tone levels, and are non-zero for levels greater than predetermined thresholds.

B.3. Quantization and Screen Generation

The cells and lattice points previously described with reference to steps 102 and 103 are defined in the Unit Square ([0,1]²) in step 104. For a given implementation, the cells need to be quantized to a given grid of W×W pixels. To compute the output at a given location in the W×W matrix for a given input tone level, the intersection of the square with side 1/W at the corresponding scaled location in the Unit Square is computed. The percentage of covered area by the scaled dots in the intersection is the output tone level. This output is quantized to the number of levels required of the output.

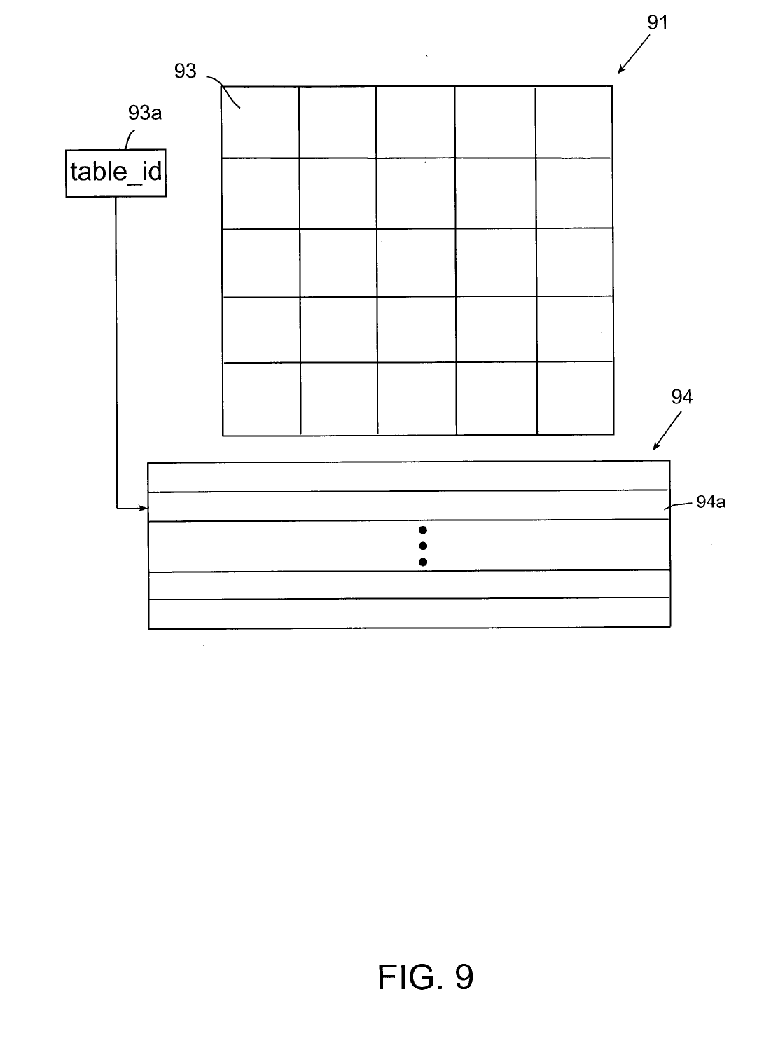

FIG. 9 shows an example of a data structure which illustrates the use of a W×W multi-frequency screen 91 (generated in step 105) to produce outputs for corresponding input tones. Each position 93 in the screen matrix includes an identification 93a to a particular table 94a (table_id) in a set of tables 94. Each table 94a contains all input levels (256 entries for 8 bit depth) and a corresponding output for each. In the illustrated example, there is at most W² tables, but usually less because of replication. For each input tone, that value is found in the corresponding location in the screen 91 and the corresponding tone is output.

The screen generated in step 105 can be thought of as a W×W matrix of vectors, where the length of each vector is the number of input tone levels. Every input tone is compared to the vector at the corresponding location in the replicated W×W matrix, and the contents of the vector corresponding to the input tone is output. The memory required to store the W×W set of vectors is compressed by a lossy vector quantization technique.

B.3.a. Consideration for PWM

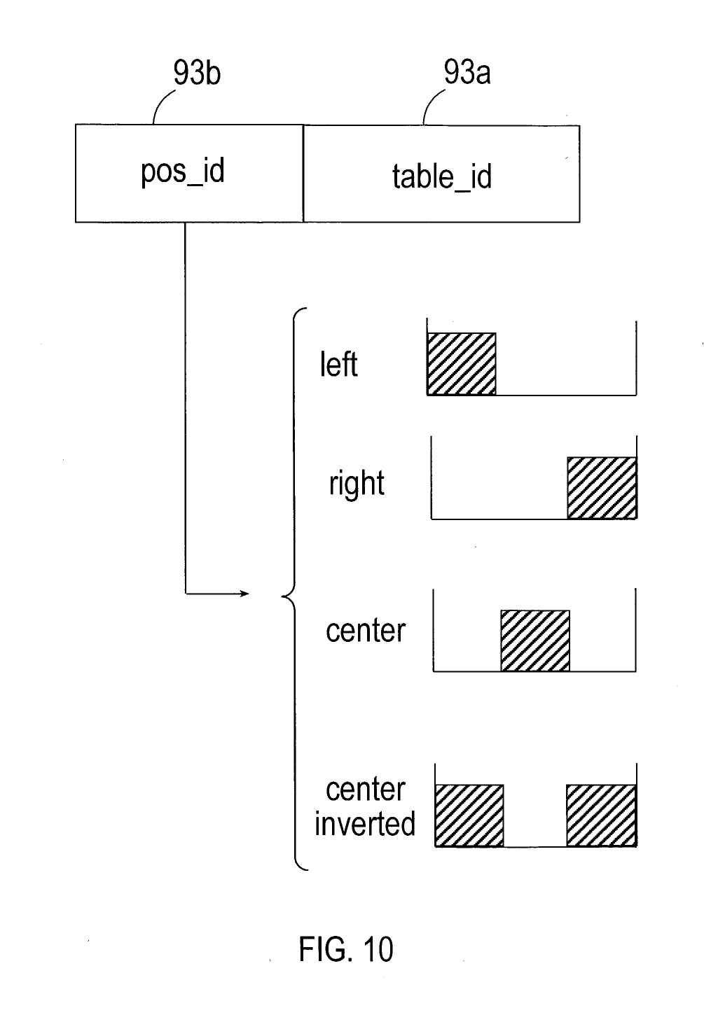

If the printer uses PWM (pulse width modulation) for rendering, the pulse widths are specified by the above outputs. In addition to pulse width information, pulse position information also needs to be generated for each location of the W×W matrix. Pulse positions should be set in a way to minimize the occurrence of isolated pulses, which are not stably rendered by laser engines. In this case, each position 93 in the screen matrix includes in addition to a table_id 93a, a position identification (pos_id) 93b identifying the position of the pulse. As shown in FIG. 10, the pos_id may indicate, for example, a pulse starting from the left, a pulse starting from the right, a center positioned pulse, or a center inverted pulse. In this case, each table 94a contains corresponding output pulse widths for the input levels.

For example, to generate the pulse position information for a printer that allows two pulse positions, e.g., starting from the left or starting from the right, the pulse position information is generated as follows. As each tone level is rendered for a given pixel, at the first occurrence of a non-zero output, if the pixel-to-the-left's output is larger than the pixel-to-the-right's output, the pulse position is marked as starting from the left. If the pixel-to-the-right's output is greater, the pulse position is marked as starting from the right. If these two neighbors have the same output, if the painted area in the left half of the 1/W square is greater, the pulse position is marked as starting from the left. If the are in the right half of the 1/W square is greater, the pulse position is marked as starting from the right. In other cases, the pulse position may be chosen randomly, assigned a fixed value, or delayed and assigned based on the pulse positions assigned to its neighbors.

C. Implementations and Effects

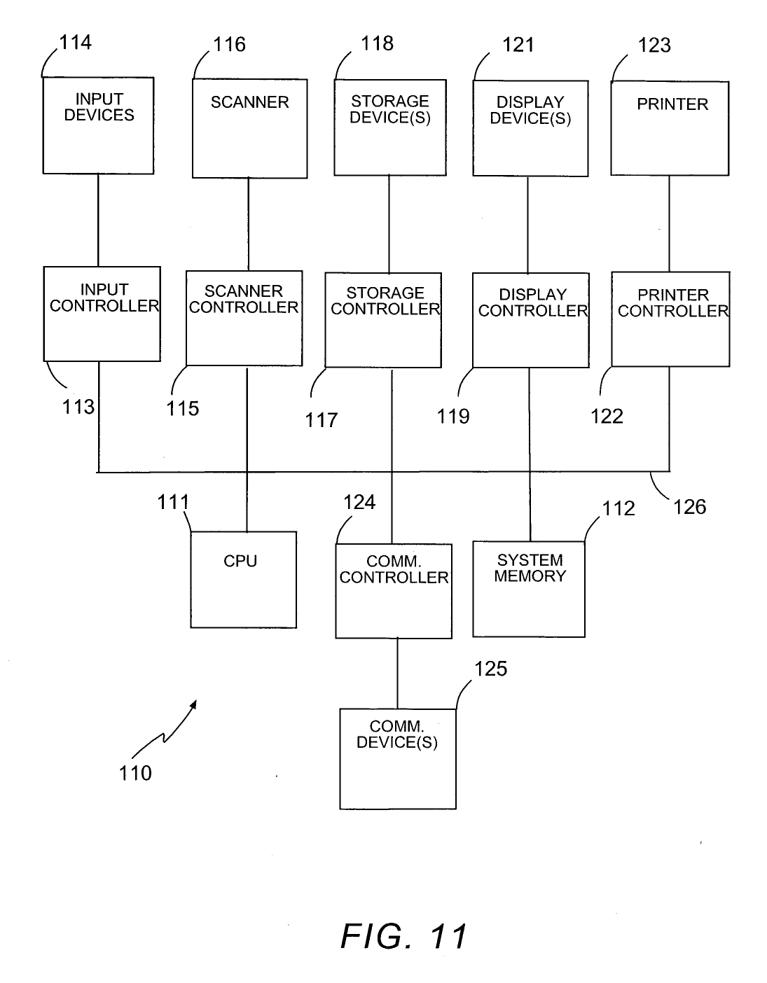

The method/algorithm of the present invention may be conveniently implemented in software which may be run on an image processing system 110 of the type illustrated in FIG. 11. The image processing system is described below in the context of a computer with peripheral devices including a printer. This is but one example of an image processing system in which the algorithm of this invention may be incorporated. The algorithm may also be embodied in other suitable arrangements.

As illustrated in FIG. 11, the system includes a central processing unit (CPU) 111 that provides computing resources and controls the system. CPU 111 may be implemented with a microprocessor or the like, and may also include a graphics processor and/or a floating point coprocessor for mathematical computations. System 110 further includes system memory 112 which may be in the form of random-access memory (RAM) and read-only memory (ROM).

Such a system 110 typically includes a number of controllers and peripheral devices, as shown in FIG. 11. In the illustrated embodiment, input controller 113 represents an interface to one or more input devices 114, such as a keyboard, mouse or stylus. There is also a controller 115 which communicates with a scanner 116 or equivalent device for digitizing documents. A storage controller 117 interfaces with one or more storage devices 118 each of which includes a storage medium such as magnetic tape or disk, or an optical medium that may be used to record programs of instructions for operating systems, utilities and applications which may include embodiments of programs that implement various aspects of the present invention. Storage device(s) 118 may also be used to store data to be processed/manipulated in accordance with the invention. A display controller 119 provides an interface to a display device 121 which may be of any known type.

In accordance with the invention, a printer controller 122 is also provided for communicating with a printer 123, which is preferably a laser printer. The processing of this invention may be embodied in the printer controller 122.

A communications controller 124 interfaces with a communication device 125 which enables system 110 to connect to remote devices through any of a variety of networks including the Internet, a local area network (LAN), a wide area network (WAN), or through any suitable electromagnetic carrier signals including infrared signals.

In the illustrated system, all major system components connect to bus 126 which may represent more than one physical bus.

Depending on the particular application of the invention, various system components may or may not be in physical proximity to one another. For example, the input data (e.g., the data used in the design of printer screens) and/or the output data (e.g., the screens generated by the method of this invention) may be remotely transmitted from one physical location to another. Also, a program that implements various aspects of the screen design process may be accessed from a remote location (e.g., a server) over a network. Such data and/or program(s) may be conveyed through any of a variety of machine-readable medium including magnetic tape or disk or optical disc, network signals, or any suitable electromagnetic carrier signal including an infrared signal.

While the present invention may be conveniently implemented with software, a hardware implementation or combined hardware/software implementation is also possible. A hardware implementation may be realized, for example, using ASIC(s), digital signal processing circuitry, or the like. As such, the claim language “machine-readable medium” includes not only software-carrying media, but also hardware having instructions for performing the required processing hardwired thereon, as well as a combination of hardware and software. Similarly, the claim language “program of instructions” includes both software and instructions embedded on hardware. Also, the “means” language used in the claims covers any appropriately configured processing devices, such as instruction-based processors (e.g., CPUs), ASICs, digital processing circuitry, or combination thereof. With these implementation alternatives in mind, it is to be understood that the figures and accompanying description provide the functional information one skilled in the art would require to write program code (i.e., software) or to fabricate circuits (i.e., hardware) to perform the processing required.

As the foregoing description demonstrates, the present invention provides an effective method/algorithm for rapidly generating a large family of screens that can be tuned rapidly to maximize screening performance for a given printer. The method/algorithm is designed so as to be particularly effective at generating screens for high resolution printing, e.g., 1200 dpi. While the invention has been described in conjunction with several specific embodiments, many further alternatives, modifications, variations and applications will be apparent to those skilled in the art that in light of the foregoing description. Thus, the invention described herein is intended to embrace all such alternatives, modifications, variations and applications as may fall within the spirit and scope of the appended claims.

What is claimed is:

1. A method for developing multi-frequency screens for a printer, comprising the steps of:
(a) generating a lattice of points by selecting a plurality of points along an imaginary line whose path extends along a surface of a geometric shape;
(b) assigning a dot shape to each of the lattice points;
(c) selecting a growth model for each dot shape;
(d) quantizing the lattice points and assigned dots to a specified grid of pixels; and
(e) generating multi-frequency screens from the lattice of points and associated dots.

2. A method as recited in claim 1, wherein the geometric shape is a torus.

3. A method as recited in claim 2, wherein a screen angle is determined as an angle made by the line with a large circle of the torus.

4. A method as recited in claim 1, wherein the dot shape assigned to a particular lattice point is determined using a tessellation.

5. A method as recited in claim 1, wherein the dot shape assigned to a particular lattice point is selected from the group of shapes consisting of circles, ellipses, and polygons.

6. A method as recited in claim 1, wherein the growth model for a particular dot shape is selected from the group consisting of uniform growth models, directional growth models, and neighborhood-dependent growth models.

7. A method as recited in claim 1, wherein the specified grid of pixels is a W×W grid of pixels, and wherein the step of quantizing comprises computing the output at each location in the W×W grid for a corresponding input tone level and quantizing each output.

8. A method for developing multi-frequency screens for a printer, comprising the steps of:
(a) generating a lattice of points by selecting a plurality of points along an imaginary line whose path extends along a surface of a torus;
(b) assigning a dot shape to each lattice point based on a tessellation of the lattice of points;
(c) selecting a growth model for each dot shape, the growth model being selected from the group consisting of uniform growth models, directional growth models, and neighborhood-dependent growth models; and
(d) quantizing the lattice points and assigned dots to a W×W grid of pixels, including computing the output at each location in the W×W grid for a corresponding input tone level and quantizing each output.

9. An apparatus for developing multi-frequency screens for a printer, the apparatus comprising:
means for generating a lattice of points, the generating means being configured to select a plurality of points along an imaginary line whose path extends along a surface of a geometric shape;
means for assigning a dot shape to each of the lattice points;
means for selecting a growth model for each dot shape;
means for quantizing the lattice points and assigned dots to a specified grid of pixels; and
means for generating multi-frequency screens from the lattice of points and associated dots.

10. An apparatus as recited in claim 9, wherein the lattice of points generating means, assigning means, selecting means, quantizing means, and the multi-frequency screens generating means are embodied in a processing device.

11. An apparatus as recited in claim 10, wherein the processing device may comprise a single integrated circuit chip or multiple integrated circuit chips.

12. An apparatus as recited in claim 10, wherein the processing device comprises any combination of the following: central processing unit, application specific integrated circuit, and digital processing circuitry.

13. An apparatus as recited in claim 10, wherein the processing device is controlled by software.

14. An apparatus of claim 9, wherein the apparatus comprises a computer, a printer, or a photocopier.

15. A machine-readable medium having a program of instructions for directing a machine to develop multi-frequency screens for a printer, the program of instructions comprising:
(a) instructions for generating a lattice of points by selecting a plurality of points along an imaginary line whose path extends along a surface of a geometric shape;
(b) instructions for assigning a dot shape to each of the lattice points;
(c) instructions for selecting a growth model for each dot shape;
(d) instructions for quantizing the lattice points and assigned dots to a specified grid of pixels; and
(e) instructions for generating multi-frequency screens from the lattice of points and associated dots.

16. A machine-readable medium as recited in claim 15, wherein the geometric shape is a torus.

17. A machine-readable medium as recited in claim 16, wherein a screen angle is determined as an angle made by the line with a large circle of the torus.

18. A machine-readable medium as recited in claim 15, wherein the dot shape assigned to a particular lattice point is determined using a tessellation.

19. A machine-readable medium as recited in claim 15, wherein the dot shape assigned to a particular lattice point is selected from the group of shapes consisting of circles, ellipses, and polygons.

20. A machine-readable medium as recited in claim 15, wherein the growth model for a particular dot shape is selected from the group consisting of uniform growth models, directional growth models, and neighborhood-dependent growth models.

21. A machine-readable medium as recited in claim 15, wherein the specified grid of pixels is a W×W grid of pixels, and wherein the quantizing instructions comprises instructions for computing the output at each location in the W×W grid for a corresponding input tone level and quantizing each output.

22. A machine-readable medium having a program of instructions for directing a machine to develop multi-frequency screens for a printer, the program of instructions comprising:
(a) instructions for generating a lattice of points by selecting a plurality of points along an imaginary line whose path extends along a surface of a torus;
(b) instructions for assigning a dot shape to each lattice point based on a tessellation of the lattice of points;
(c) instructions for selecting a growth model for each dot shape, the growth model being selected from the group consisting of uniform growth models, directional growth models, and neighborhood-dependent growth models; and
(d) instructions for quantizing the lattice points and assigned dots to a W×W grid of pixels, including instructions for computing the output at each location in the W×W grid for a corresponding input tone level and quantizing each output.
